(19) United States
(12) Patent Application Publication
(10) Pub. No.: US 2009/0125457 A1
(43) Pub. Date: May 14, 2009

(54) SELF-SERVICE, MONITORED AND CONTROLLED BEVERAGE DISTRIBUTION AND DISPENSING SYSTEM

(76) Inventors: FARIBORZ M. FARHAN, Alphretta, GA (US); Jeffrey I. Libby, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/938,855

(22) Filed: Nov. 13, 2007

(51) Int. Cl. B67D 5/00; B67D 5/08

(52) U.S. Cl. 705/413; 222/23

(57) ABSTRACT

A beverage distribution system is offered for the purpose of self-service beverage dispensing, capable of providing customers real-time feedback on beverage consumption levels. The system includes a network of control stations and patron stations which are in constant communication via a wired or wireless network. The system is capable of detecting low beverage levels in beverage containers when or before they occur and can inform wait staff of such events. Furthermore, wait staff is provided with the tools to perform intelligent control of the self-service consumption according to local laws as well as paying visits to patrons at the appropriate time resulting in a very efficient system. A novel valve control scheme is also offered that is energy efficient, that does not generate undesirable heat in the presence of cooled beverages. Also, a generic flow control for beverage distribution is presented.

### BACKGROUND OF THE INVENTION

### Field of Invention

The present invention relates to the field of beverage distribution, and more particularly to a beverage distribution and/or dispensing system enabling patrons the ability of having self-service dispensing while maintaining full remote control by any wait personnel.

Alcohol consumption is a favorite pastime globally and, in particular, beer consumption is the predominant alcoholic beverage at many restaurants and sports bars in the developed world. The existing laws attempt to define boundaries to maintain responsibility of persons who serve alcoholic beverages as well as to promote responsible drinking. To some extent and under certain circumstances, laws such as the Dram Shop Act have been used in court to hold the server responsible for the actions of the drinking patron. Such liabilities require the server to be trained and skilled to perform the function of serving alcoholic beverages effectively and responsibly. Many references have attempted to define a self-service beer dispensing scheme, but fall short of providing the wait personnel the necessary tools or means to monitor total consumption as a function of time, thus rendering them ineffective.

An examination of the prior art helps to demonstrate the novelty and non-obviousness of the various embodiments, aspects and features of the present invention. For instance, one system provides a technique for indicating and controlling dispensing beverages for hotel rooms without providing any provision for a restaurant or a waited atmosphere. This system also does not include an actual flow control mechanism. Another technique in the field is a mechanical beverage dispensing scheme that is not suitable for any self-service application. Another system provides an improved mechanical beverage dispensing scheme for a more accurate dispensing of beer.

However, the aforementioned systems or techniques leave a need in the art. Namely, there is a need in the art for a system that can promote responsible drinking by patrons, overcome some liability issues associated with service providers and, also provide a way to manage the distribution of beverages to multiple locations and maintain operational capacities for the reservoirs or tanks feeding the destinations. Thus, there is a need in the art for an alcoholic beverage distribution and self-service system that provides real-time consumption status and feedback to the patron as well as the wait personnel, alerts the management of the establishment on beverage container near empty or low levels, alerts the wait personnel when to make visits to the patron for further service and/or to monitor excessive consumption, and does not rely on a card reading scheme.

### BRIEF SUMMARY OF THE INVENTION

According to one embodiment of the present invention, one or more beverage sources are connected to one or more beverage dispensing self-service destination stations via a distribution network of pipelines. Each destination self-service station can be used by one or more patrons or even wait personnel. Each line originating from a source can be split to serve more than one destination. At the destination, there can be one or more dispensing apparatus similar to a beer tap for an entire table or one or more dispensing apparatus per each beverage source. For some beverages, such as those for which an after taste or taste corruption is an issue, one dispenser shall be used per beverage type and not shared with other beverages. Each beverage line is equipped with a flow-meter and one or more on-off valves to monitor the rate and amount of consumption as well as to allow or disallow the flow of the beverage liquid. In one embodiment of the invention, a single valve is used with a single flow meter hence providing a cost-effective alternative. At the patron end, a digital display is equipped to provide real-time feedback to one or more clients. The feedback can include the total amount of beverages consumed since the beginning (i.e., since the patron sat down at the establishment, or for that particular day, or for a particular time frame), the rate of consumption and any messages from the establishment or the wait personnel. It can additionally serve as a means to call the wait personnel when help is needed. Since the patron is in charge of his or her own pouring, the role of the valve is to enforce the rules of the establishment, hence does not have to perform an expensive variable pouring function.

According to another embodiment of the invention, when the beverage is alcoholic requiring a set of controls by a wait personnel, the present invention employs algorithms to alert the wait personnel at the instant that the consumption thresholds, set by local law or establishment, have been exceeded. The display at the client table can be used to inform the patrons of such thresholds in addition to their compliance thereof.

According to another embodiment of the invention, low beverage levels are detected, without the need for any sophisticated hardware or cost, by measuring the instantaneous flow-rate and comparing that to a full-rate.

According to another embodiment of the invention, a networked scheme is used to allow one or more control terminals, representing the establishment, to control one or more client stations. The invention can support wired or wireless networking schemes.

According to yet another embodiment of the present invention, consumptions levels of every beverage container, or beer keg is known at all times without the need for any additional hardware on or near the container. Also, an alert scheme is offered to the management of the establishment when the container levels fall below a certain level by calculating total consumption of all lines associated with a given keg and also by looking at the instantaneous flow rate of beverage associated with the given keg.

According to yet another embodiment of the present invention a generic liquid distribution is offered, that allows any number of sources (beverage reservoirs or containers) to be connected to any number of destinations (beverage dispensers).

Thus, one embodiment of the invention is a beverage distribution system that supports one or more beverage sources. The system includes multiple dispensing stations from which the beverage can be obtained in a self-service manner. The dispensing stations include a display, a dispenser, a valve and a flow meter that are all under the control or interfaced with a controller. Thus, the controller can receive flow measurements from the flow meter, cause the flow meter to make measurements, provide reporting information on the display device and control the operation of the valve, among other things. In addition, a piping network interconnects the beverage sources and the dispensing stations, wherein the flow meter and the valve of the dispensing station are connected in series between the dispenser of the dispensing stations and the beverage sources. The piping network is constructed such that each dispenser is connected to one beverage source, whereas each beverage source may be connected to multiple dispensers. Thus, with each dispenser being connected to a beverage source through at least one valve for flow control and a flow meter, consumption can be measured and monitored on a dispenser level. Further, by being communicatively coupled to a control station, the consumption associated with each dispenser and each beverage source can be ascertained. Operating like a central controller, the control station can track the consumptions and exercise control or raise alerts on either a dispenser level or on a beverage source level. Thus, one aspect of the invention operates to compare the measured consumption for a dispenser to a threshold value received from said control station and determines the appropriate valve control action to take based on the comparison. For instance, if a volume is exceeded the valve can be shut down.

These and other embodiments, features and aspects of the present invention will be more readily understood upon referring to the detailed description and the accompanying figures.

### BRIEF DESCRIPTION OF THE SEVERAL VIEWS OF THE DRAWING

FIG. 1 is a system diagram illustrating the various components of an exemplary embodiment of the present invention.

FIG. 2 is a circuit and timing diagram illustrating a particular valve switch that could be used in an exemplary embodiment of the present invention.

FIG. 3 is a flow diagram illustrating the control flow and an algorithm for monitoring and controlling alcoholic beverage consumption.

FIG. 4 is a plot illustrating the control flow versus time as observed from a wait personnel perspective.

FIG. 5 is an illustration of a typical content on display at the patron station.

FIG. 6 is a block diagram illustrating the communication between the client stations and the control stations.

FIG. 7 is a flow diagram illustrating a beverage reservoir maintenance and control feature of the present invention.

FIG. 8 is an interconnection diagram illustrating the connections between beverage sources and destination in an exemplary embodiment of the present invention.

### DETAILED DESCRIPTION OF THE INVENTION

In general, the various embodiments, aspects and features of the present invention provide the ability to distribute beverages to locations, monitor beverage consumption, and/or control the delivery of beverages. More specifically, one aspect of the present invention is a network for the delivery of beverages from one location (i.e., a central location) to one or more remote destinations (i.e., patron tables). One aspect of the present invention is to provide a mechanism to control which beverages are available at certain locations. Another aspect of the present invention is to monitor the amount of beverage consumed by one location, table or patron. Another aspect of the present invention is to track the total amount of beverage consumption of a particular source to determine when the source requires servicing (such as refilling or replacement). Turning now to the figures in which like labels refer to like elements throughout the several views, these various embodiments, features and aspects of the present invention, as well as others are described.

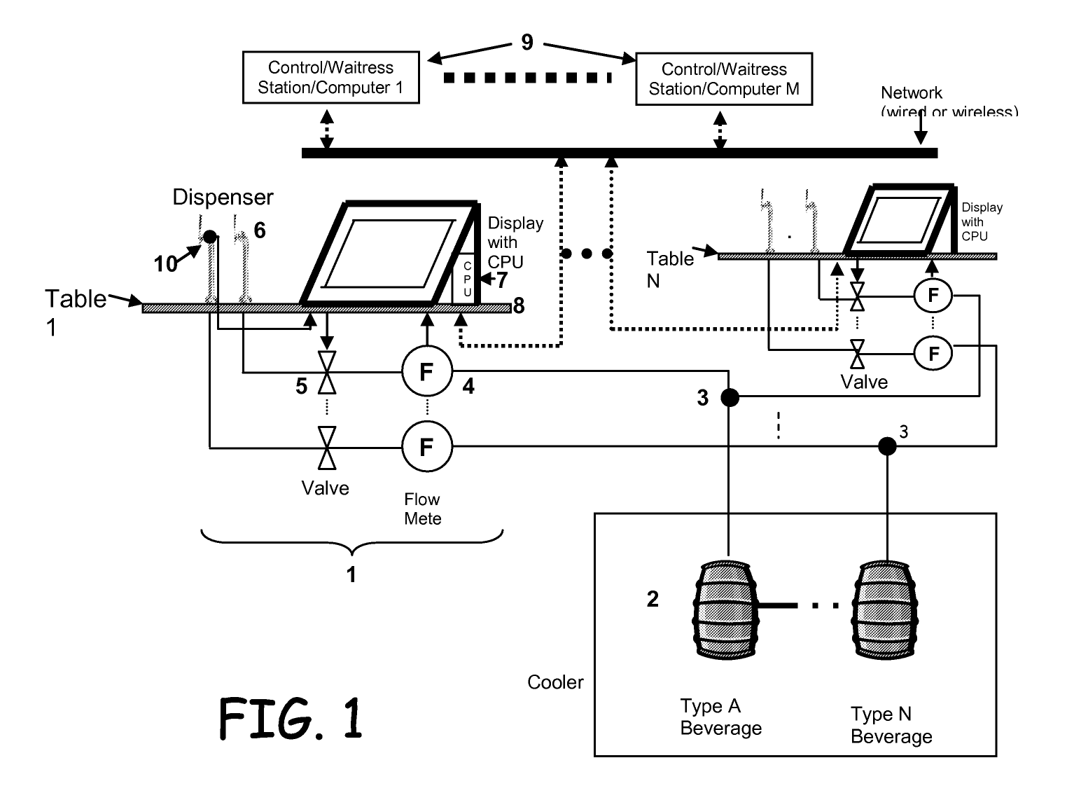

FIG. 1 is a system diagram illustrating the various components of an exemplary embodiment of the present invention. The illustrated embodiment shows a plurality of beverage reservoirs or source containers 2, connected to a plurality of self-service dispensing stations 1, via a number of line splits 3, each dispensing station having at least one dispenser or tap, designated as 6, and a display with internal micro-computer or Central Processing Unit-CPU, 7. Each dispenser or tap is associated with a valve 5 and a flow meter 4. Valves 5 and flow meter 4 are installed in series with the beverage line and can be located anywhere along the beverage line that is appropriate. The display is associated with a patron table or physical location to serve at least one patron. Therefore each patron table can have one or more self-service dispensers, but only needs one display.

The flow meter 4 is in communication with the CPU 7, sending pulses representing flow of fluid in the line. The CPU totalizes the liquid flow for each liquid line, calculates the average consumption rate typically measured in ounces per hour and also monitors instantaneous flow rate, typically measured in ounces per minute.

In another embodiment of the present invention each dispenser or tap can be equipped with a simple electric switch 10, that closes an electric circuit when the dispenser or tap is opened in full position. The purpose of this switch is to inform that CPU that the patron is attempting to pour at full rate. This information will enable the CPU to report an alarm condition when the tap is fully open. When the tap is fully open the CPU should expect full speed liquid flow, but if the flow meter 4 is reporting a much slower rate, then the condition will be reported to the Control station 9.

The CPU 7, is in communication with at least one Control or Wait person station, 9. The Control station 9, can send commands to the CPU of each service station to turn the display on or off, reset its timer when a new client is seated, and/or turn the valve in each beverage line on or off. In return, the CPU 7 at each service station reports back totalized beverage consumption per each dispenser or tap 6. Each dispenser or tap is associated with a certain beverage reservoir (or keg in the case when the beverage is beer). The control station 9 is aware of the association of each and every dispenser with each and every reservoir. Therefore by monitoring the consumption at each dispenser the total consumption at the beverage reservoir is known. This enables the establishment management to manage their beverage containers effectively and be alerted without any need for additional hardware or equipment. For convenience the establishment may choose to have a control station near or at the beverage reservoir location. This can help the beverage service people to efficiently service the beverage source containers.

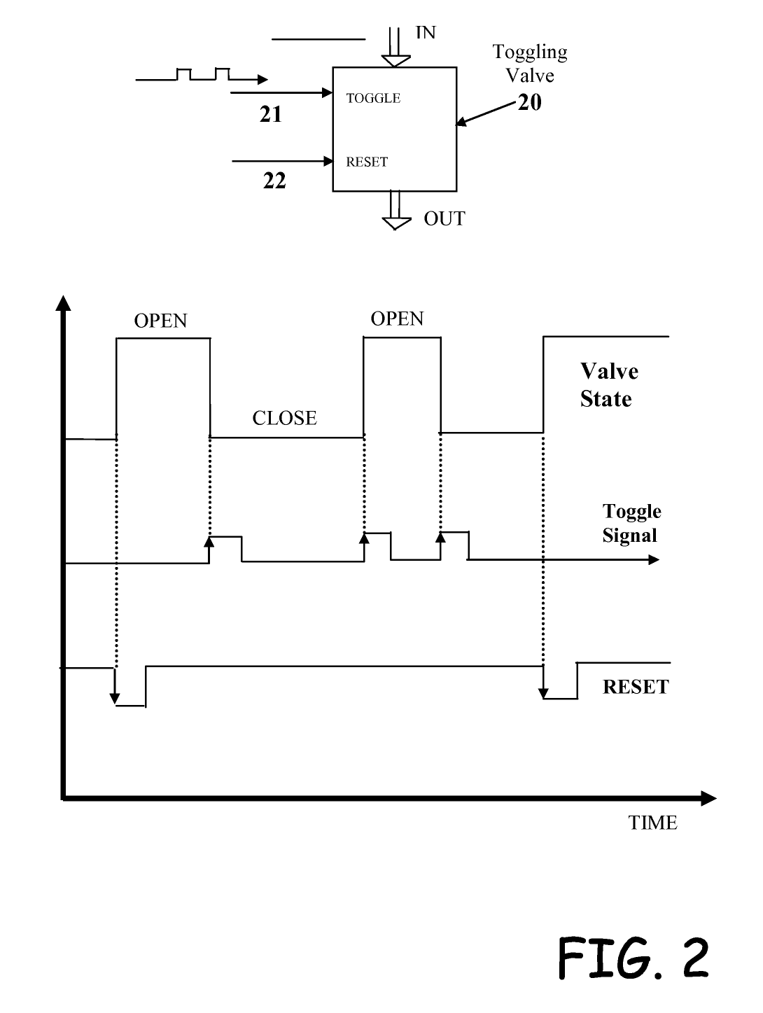

FIG. 2 is a circuit and timing diagram illustrating a particular valve switch that could be used in an exemplary embodiment of the present invention. The illustrated valve in this embodiment is a toggle valve 20. The advantage that a toggle valve provides is that it is very energy efficient. In most applications when a patron is seated and the waitress turns on the station valve 5, conventional Normally Closed valves would get energized and open and remain open, as long as the electrical energy is applied. This consumes energy, but more importantly generates heat. This could have an undesirable effect on a cooled beverage such as beer. A toggle valve 20, as shown in FIG. 2, would typically have two control input signals namely RESET 22 and TOGGLE 21. The RESET signal 22 always forces the toggle 20 to an open position, while the rising edge of the TOGGLE signal 21 always changes or toggles the current state of the valve. A typical signal flow and valve reaction is shown in the bottom of FIG. 2. Moving from left to right on the time scale diagram, the first event is a falling edge of the RESET signal 22 which opens the valve as shown. The subsequent series of TOGGLE signal 21 includes three pulses, each of which respectively toggles the valve from open to close, close to open and finally open to close state on the rising edge of the signal. And finally, a negative or falling edge of a subsequent RESET signal 22 will force the valve to open.

When the beverage consumed is an alcoholic beverage such as beer, local laws may require the wait personnel to monitor and control the consumptions of alcohol. In some areas the local regulations require the wait personnel to perform constant checks on patrons. When a self-service dispensing station or system is offered, a different control mechanism would be required to allow remote monitoring of alcohol consumption by the wait personnel or management of the establishment, since now the consumer can theoretically pour endlessly. Prior to the current invention this control mechanism was implemented via a card-reader at the patron self-service station. Card readers are expensive and introduce an additional cost burden for the establishment and inherently cannot provide feedback to the patron on the total consumption. Furthermore, a card reading mechanism is not a real-time solution. The present invention, however, is a real-time solution. The wait person can monitor consumption real-time at the level of each dispenser, table or reservoir (beer keg).

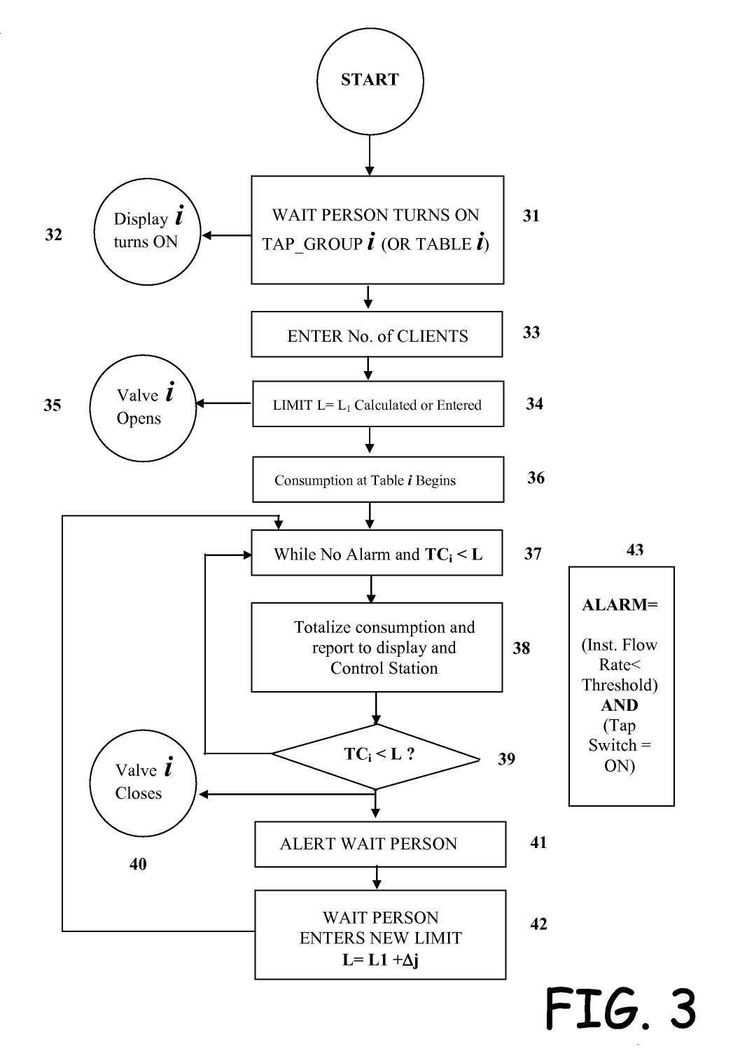

FIG. 3 is a flow diagram illustrating the control flow and an algorithm for monitoring and controlling alcoholic beverage consumption. In FIG. 3, the process begins by a client asking for a self-service table. The wait person enters a command at the wait/control station to turn on a certain table i, step 31. As a result the display at the table i is enabled and turns on. The wait person enters the number of clients, step 33, and either enters a threshold limit L, step 34, or uses the default number calculated automatically by the control station based on local or establishment rules and regulations. At this point, step 35, the valves associated with the table open. The wait person has the option to override any or all of these actions. For example if certain beverage container or beer keg associated with a dispensing tap is not available, then the valve shall not open. From this point on, consumption can begin—step 36. In a control loop 37-39, CPU 7 is constantly monitoring for lack of alarm and totalizing consumption per dispensing tap and reporting in step 38, to Control/Wait station 9. Alarm condition is defined in step 43 and that is when (Tap switch 10 is=ON) AND (Instantaneous Flow Rate<Alarm) Threshold. If this alarm condition occurs it would be indicative of either a low pressure or even empty reservoir tank. The wait personnel and management will be instantly notified as in step 41.

Any information that is available to the patron on display 7, is also available to wait personnel at station 9 within a reasonable delay (<1 minute). At step 39, CPU 7 compares the current total consumption for a given table or patron against the last limit stored in memory. If the total consumption is still within an imposed limit, the loop continues. If not, the valve closes as in step 40 and wait person is alerted per step 41. The wait person, depending on local rules, will visit the table to check on patrons. When he or she returns to his or her control station, a new limit L=L₁+Δⱼ can be entered, step 42 and loop 37-39 can continue. Alternatively, the wait person can close the table and charge the customers. The value of Δⱼ is the increment to the next level or limit for beer or alcohol consumption established by local rules.

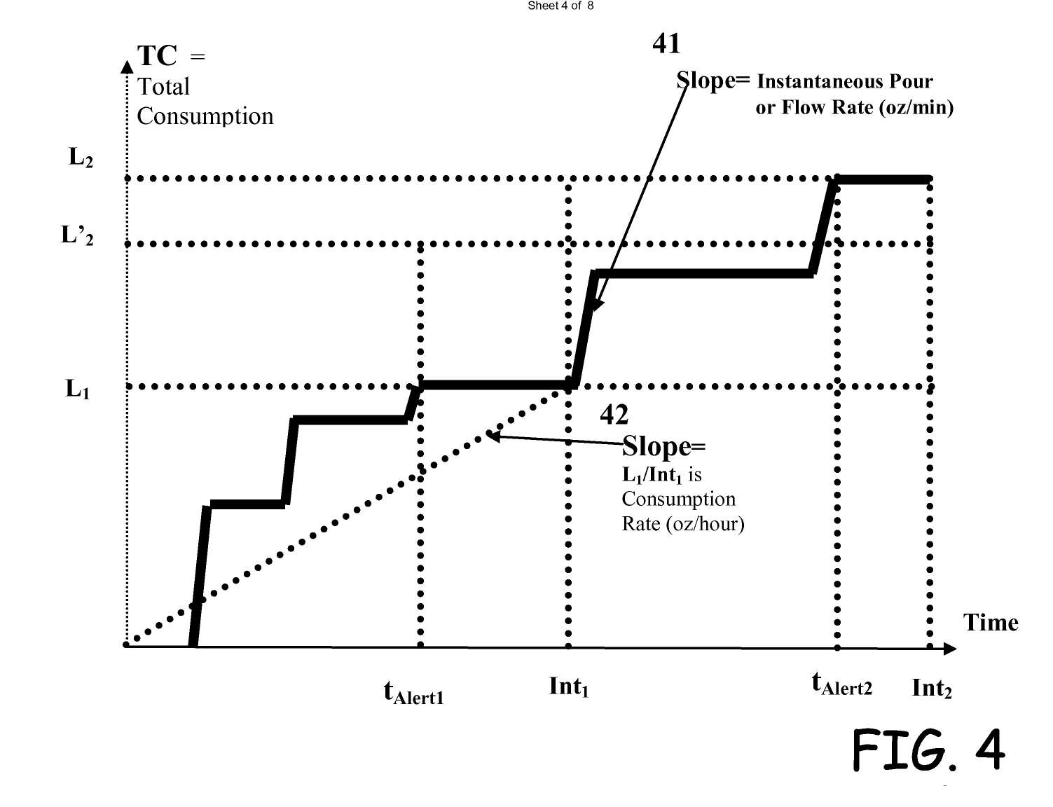

FIG. 4 is a plot illustrating the control flow versus time as observed from a wait personnel perspective. This plot is an illustration of a typical consumption and control scenario. The graph starts when a number of patrons, (at least one) are seated at a table and self-service consumption has been enabled. A limit L₁ is calculated by default, based on a simple rule of N*Limitₚₑᵣₛₒₙ (where Limitₚₑᵣₛₒₙ is established by management) or entered by wait person manually. Int₁ represents the time interval expected for the consumption of L₁. Typically the patrons would consume the L₁ limit by t_{Alert1} and at that point the wait person is alerted and required to attend the table, make an assessment of the situation with the patrons, inform management, get management approval if required before setting the new limit to L2′. Typically L2′<L2, where L2=L₁+Δ_{j,} indicating that the establishment may want to slow down the consumption process and speed up the next alert event. The present invention offers all the necessary tools and features for any establishment to create their own waiting rules in accordance with local laws and regulations. The purpose of the example presented in FIG. 4 is to illustrate one of many possible scenarios. It should be clear to the person skilled in the art that the invention offers all the necessary flexibility to set all the thresholds according to the local rules or arbitrary rules imposed by the establishment.

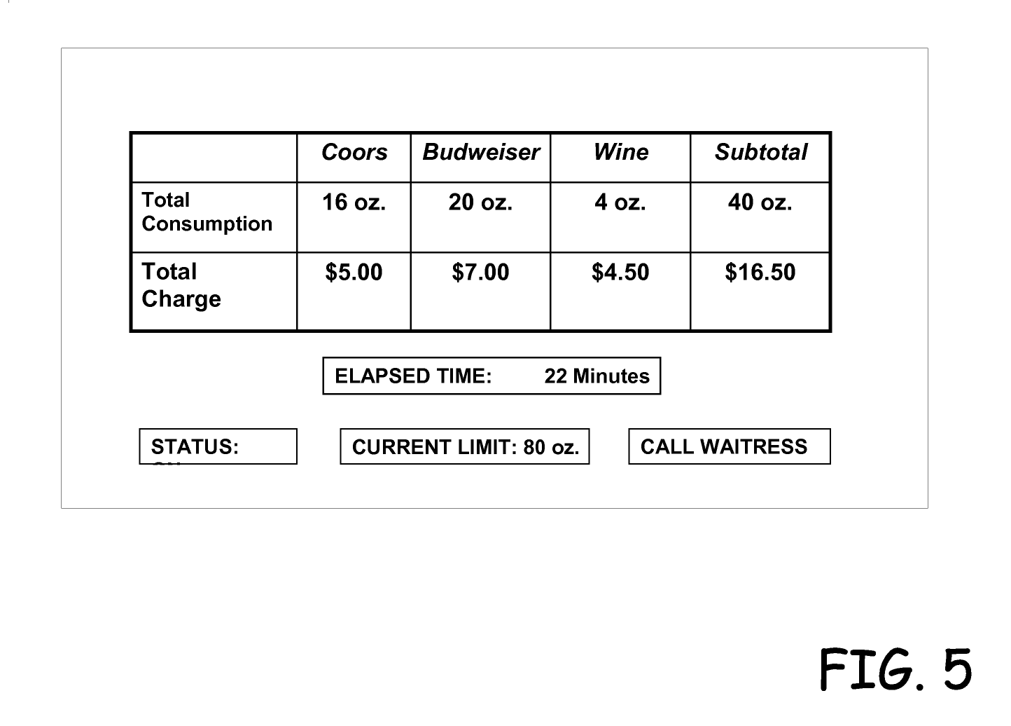

FIG. 5 is an illustration of a typical content on display at the patron station. FIG. 5 illustrates another feature offered by the present invention—the ability to provide detailed feedback to the consuming patrons in real-time. The columns represent the beverage types, including a totals column, and the rows represent total consumption during the elapsed time in ounces (or milli-Liter) and in currency. The display can also show the elapsed time, the status of the table and the current threshold for wait person action. The illustration also shows a soft key button “CALL WAITRESS” as an option to call the wait person. When beverage is poured the CPU will update the display in real-time.

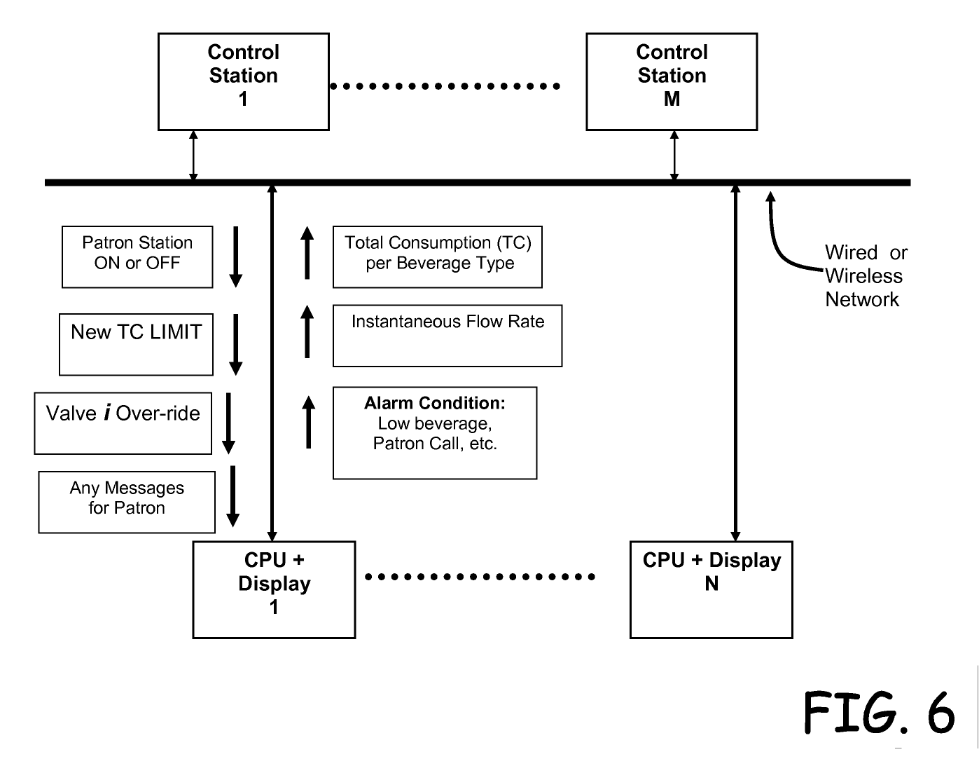

FIG. 6 is a block diagram illustrating the communication between the client stations and the control stations. The messages that are sent by the Control station include:
a) Station On or OFF-
b) Valveᵢ over-ride
c) Total Consumption Limit
d) Any other text or graphical message
   The messages that are sent from the client station to the control station can include:
e) Total Consumption per beverage type; on a frequent basis (sent once a minute)
f) Instantaneous flow rate if below an expected level (sent per occurrence ) as an alarm condition
g) Any alarm or alert conditions (sent per occurrence)

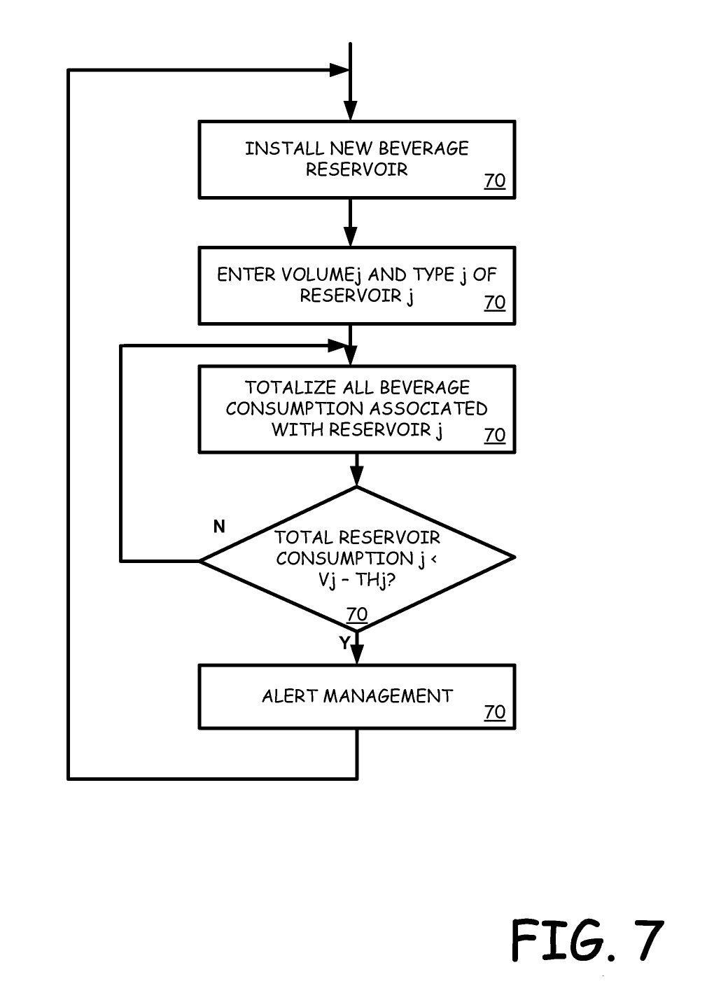

FIG. 7 is a flow diagram illustrating a beverage reservoir maintenance and control feature of the present invention. When a new beverage container, reservoir or keg is installed as in step 70, the volume of the reservoir Vⱼ and the typeⱼ of beverage is entered into the control station menu as in step 71. An association is established between all client dispenser taps that are connected to this reservoir. In the loop represented by steps 72-73 the total amount of beverage consumed by dispensers associated with this reservoir is totalized by the control station and compared against a threshold value (i.e., Vⱼ−Thⱼ). The threshold (Thⱼ) is the level above an empty tank level, measured typically in ounces, that the establishment would determine as the point at which the container needs replacement.

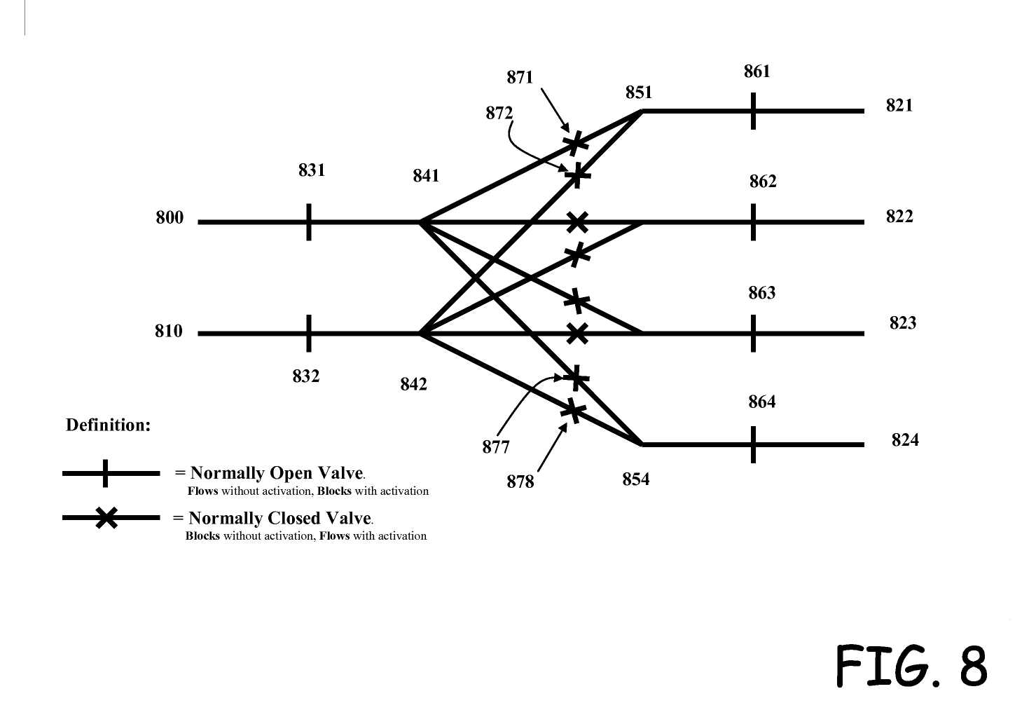

FIG. 8 is an interconnection diagram illustrating the connections between beverage sources and destination in an exemplary embodiment of the present invention. The interconnected components represented in FIG. 8 is simply a generic interconnection system between an arbitrary number of sources, (N>1) of beverage or liquid, namely 800 and 810 and an arbitrary number of terminals or destinations, (M>1) namely 821, through 824. The supply of each source is split (i.e., for source 800 at 841 and for source 810 at 842) M number of times and followed by a Normally Closed valves 871, . . . ,878 and then followed by a combining node 851, . . . ,854, where N number of lines are combined, and finally terminating at beverage terminals 821, . . . ,824. This scheme allows any beverage source to be directed to any beverage terminal. To illustrate this, please consider the flow of liquid into 821. If only source 800 is desired 871 will activate and open and 872 will remain closed. If mixing of two beverages is desired, both 871 and 872 are activated and open. If no flow is desired then both 871 and 872 are deactivated and close.

In FIG. 8, the Normally Open valves, 831 and 832, allow an option to shut off the source to all terminals. This option can be useful when the beverage reservoir needs to be replaced or refilled.

Also, in FIG. 8, the Normally Open valves of 861, 862, 863 and 864 provide an option to shut off the terminal regardless of the state of the source or any in line valve. This allows additional flow control at a given terminal when needed.

In the generic interconnect scheme of FIG. 8, if the sources and destinations were swapped all of the above would still apply. In other words if 800 and 810 become beverage terminal and 821, 822, 823 and 824 become beverage sources, all of the above would apply.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A beverage distribution system comprising:
one or more beverage sources;
a plurality of dispensing stations for the purpose of providing self-service dispensing of beverages from the one or more beverage sources, each dispensing station comprising:
a display;
a dispenser for providing an access point for the self-service dispensing control of a beverage from a one beverage source;
at least one valve for the flow control of beverage from the beverage source;
a flow meter that measures the amount of liquid passage as a function of time; and
a controller coupled to the display device, the valve and the flow meter, the controller being operative to receive flow measurements from the flow meter, present information pertaining to the dispensing from the beverage source on the display device, and controls the operation of the valve; and
a piping network interconnecting the one or more beverage sources to the dispensing stations, wherein the flow meter and the at least one valve are connected in series between the dispenser of the dispensing stations and the beverage sources.

2. The beverage distribution system of claim 1, wherein each dispenser is connected to one beverage source, while each beverage source is connected to one or more dispensers.

3. The beverage distribution of claim 2, wherein each dispenser is connected to a beverage source through at least one valve for flow control and at least one flow meter for consumption rate measurement.

4. The beverage distribution system of claim 1, wherein the controller interfaces with the flow meter to calculate the total and individual consumption for each beverage source and presents the results on the display device.

5. The beverage distribution system of claim 4, further comprising a control station that can interface to the controllers of a plurality of dispensing stations and wherein a dispensing station controller, in response to a message from the control station, compares the measured consumption for a dispenser to thresholds received from said control station and determines the appropriate valve control action to take based on the comparison.

6. The beverage distribution system of claim 5, wherein the beverage source provides an alcohol based beverage and the controller allows consumption alert limits to be set for each dispenser as a function of the individual dispenser and, in response to reaching an alert limit, requesting a merchant to visit the dispensing station.

7. The beverage distribution system of claim 6, wherein the controller allows for setting alert consumption limit thresholds in a decreasing trend algorithm, such that each new consumption step is a fraction, smaller than one, of the previous step, and will automatically increase the number of requests for a merchant to visit to a dispensing station should the consumption rate persist.

8. The beverage distribution system of claim 4, wherein the control station notifies the dispensing station controller to start or stop the consumption of beverages regardless of total consumption.

9. The beverage distribution system of claim 4, wherein a control algorithm operating within the control station totalizes all consumptions associated with a given beverage source by collecting consumption information from every dispenser station and if the sum of the consumption information is within a threshold limit of the beverage source capacity less arbitrary buffer level, alerting a merchant so that appropriate measures can be taken.

10. The beverage distribution system of claim 4, wherein the dispenser station is equipped with an electric switch that closes a circuit whenever the dispenser is fully opened, the closed circuit providing a signal to the dispenser station controller of such event and the controller responding by measuring the liquid flow rate and comparing it against an expected peak flow rate and, if the liquid flow rate is less than the expected peak flow rate by a threshold percentage, transmitting an alarm condition to the control station to report a beverage low level condition.

11. A toggle type valve that can be used as a replacement of any conventional valve for liquid distribution, the toggle type valve providing a low power and low heat generating valve for applications limited to binary control schemes.

12. The toggle type valve of claim 11, comprising a liquid input port, a liquid output port, an electrical toggle control input and an electrical reset control input, wherein an electrical pulse at the toggle input will force a state change of said valve, while an active electrical input at the reset port will force a known outcome.

13. A system for interconnecting a number of liquid sources to another number of liquid terminals, each source connected to a split point with a number of fan-out branches equal to the number of said terminals, followed by an on-off valve, that is normally closed and opens when energized, followed by a combining node with a number of fan-in branches equal to number of liquid sources and one output branch connected to each of the liquid terminals.

14. The system for interconnecting of claim 13, wherein a beverage is accessed by activating and deactivating the normally closed valve that is in-line with the desired beverage source, thus allowing exclusive dispensing, mixed dispensing and no dispensing;

15. The system for interconnecting of claim 13, wherein normally open valves can be placed in the flow path to activate or deactivate a given source or terminal.

16. The system for interconnecting of claim 13, further comprising a dispensing station that detects, monitors and records liquid flow relevant to the dispensing station, and a control station that controls the state of the on-off valves.

17. The system for interconnecting of claim 16, wherein the dispenser station further includes a valve that can be opened or closed by the dispensing station.

18. The system for interconnecting of claim 17, wherein the dispensing station reports consumption information to the control station and is subject to the control of the control station.
